(19) United States
(12) Patent Application Publication
(10) Pub. No.: US 2010/0166642 A1
(43) Pub. Date: Jul. 1, 2010

(54) METHOD FOR PRODUCING ALUMINA

(75) Inventors: Noriaki FUJITA, Ehime (JP); Shinji FUJIWARA, Ehime (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/647,673

(22) Filed: Dec. 28, 2009

(30) Foreign Application Priority Data
Dec. 25, 2008 (JP) 2008-331137

(51) Int. Cl. C01F 7/02

(52) U.S. Cl. 423/625

(57) ABSTRACT

A method for producing alumina comprising the steps of mixing an aqueous medium in an amount of 20 parts by weight or more and 300 parts by weight or less with 100 parts by weight of a first dry powdery aluminum hydroxide prepared by an aluminum alkoxide method to give a wet powdery aluminum hydroxide; drying the wet powdery aluminum hydroxide by an agitation drying system to give a second dry powdery aluminum hydroxide; and calcining the second dry powdery aluminum hydroxide to give alumina having a high bulk density.

### FIELD OF THE INVENTION

The present invention relates to a method for producing alumina.

### BACKGROUND ART

Alumina is widely used in industry as a raw material of ceramic materials, etc. In particular, powdery alumina is used as a raw material of high density sintered bodies, a raw material of single crystal sapphire, abrasives and a wide variety of fillers. As an example of a method for producing such alumina, a method comprising calcining a dry powdery aluminum hydroxide, which is prepared by an aluminum alkoxide method, without treating the dry powdery aluminum hydroxide before calcination is known. In one typical production method, powdery aluminum hydroxide is filled in a calcination vessel such as a sheath and then calcined in order to prevent the powder from scattering (see JP-A-8-301616, in particular, paragraphs [002] and [0003]).

However, the dry powdery aluminum hydroxide prepared by the aluminum alkoxide method has a low bulk density and, in turn, a low volume efficiency. Therefore, the aluminum alkoxide method may not be necessarily regarded as an industrially advantageous method.

### SUMMARY OF THE INVENTION

An object of the present invention is to provide an industrially advantageous method for producing alumina having a high bulk density at a high volume efficiency.

Another object of the present invention is to provide a method for producing alumina which contains less coarse agglomerated particles.

Accordingly, the present invention provides a method for producing alumina comprising the steps of: mixing an aqueous medium in an amount of 20 parts by weight or more and 300 parts by weight or less with 100 parts by weight of a first dry powdery aluminum hydroxide prepared by an aluminum alkoxide method to give a wet powdery aluminum hydroxide;

drying the wet powdery aluminum hydroxide by an agitation drying system to give a second dry powdery aluminum hydroxide; and

calcining the second dry powdery aluminum hydroxide to give alumina.

According to the production method of the present invention, it is possible to produce alumina containing less coarse agglomerated particles at a high volume efficiency from a dry powdery aluminum hydroxide which is prepared by an aluminum alkoxide method.

### DETAILED DESCRIPTION OF THE INVENTION

In the present invention, the aluminum alkoxide method means a method comprising hydrolyzing an aluminum alkoxide to give aluminum hydroxide, which is, for example, in the form of a slurry, a sol or a gel, and then drying the aluminum hydroxide to give a dry powdery aluminum hydroxide.

For example, the aluminum alkoxide is a compound represented by the formula (1):

Al(OR¹)(OR²)(OR³) (1)

wherein R¹, R² and R³ independently from each other represent an alkyl group.

Examples of the alkyl group for R¹, R² and R³ in the formula (1) include an alkyl group having 1 to 4 carbon atoms, such as a methyl group, an ethyl group, an n-propyl group, an isopropyl group, an n-butyl group, an isobutyl group, a sec-butyl group and a tert-butyl group. Specific examples of the aluminum alkoxide include aluminum isopropoxide, aluminum ethoxide, aluminum sec-butoxide and aluminum tert-butoxide.

The aluminum hydroxide in the form of a slurry or the like obtained by hydrolyzing the aluminum alkoxide usually has an average primary particle diameter of 0.01 to 1 μm, preferably 0.02 to 0.05 μm. The average primary particle diameter is determined by observation of particles using a transmission electron microscope (TEM). Specifically, the average primary particle diameter is determined by taking a TEM photograph including the images of at least 20 particles, measuring the length of each of the images of about 20 particles, calculating the arithmetic mean of the lengths, and dividing the mean by the magnification of the TEM photograph. More specifically, the average primary diameter of particles is determined by the following method. An axis which is in parallel with a straight line drawn in the TEM photograph is assigned as an X-axis. Then, as for the image of each of the about 20 particles, the projected length on the X-axis of the image is measured. The arithmetic mean of the projected lengths of the images of the about 20 particles is calculated and the mean is divided by the magnification along the X-axis of the photograph. The obtained quotient is used as the average primary particle diameter of particles referred.

The first dry powdery aluminum hydroxide obtained by drying the aluminum hydroxide in the form of a slurry or the like comprises fine particles usually having a low bulk density of 0.1 to 0.2 g/cm³. Herein, a bulk density means an apparent density defined in JIS 28901. Further, the first dry powdery aluminum hydroxide usually has a BET specific surface area of about 200 to 400 m²/g. Herein, a BET specific surface area is determined by a nitrogen adsorption method according to the method defined in JIS 28830. In addition, the first dry powdery aluminum hydroxide usually has an average secondary particle diameter of about 5 to 20 μm. Herein, an average secondary particle diameter is determined by measuring a particle diameter distribution by a laser scattering method and finding the diameter of particles at a cumulative percentage of 50% by weight as an average secondary particle diameter.

In the production method of the present invention, the first dry powdery aluminum hydroxide is mixed with an aqueous medium. As the aqueous medium, water alone or a mixed medium of water and a water-soluble alcohol may be used. The water-soluble alcohol is not particularly limited, but a low-boiling alcohol having 3 or less carbon atoms, such as methanol, ethanol, propanol and isopropanol is preferably used to enhance the energy efficiency during drying of wet aluminum hydroxide.

The amount of water in the mixed medium is preferably 70 parts by weight or more per 100 parts by weight of the mixed medium, since such an amount of water enables the formation of the second dry powdery aluminum hydroxide having a higher bulk density after drying the wet powdery aluminum hydroxide.

The wet powdery aluminum hydroxide can be obtained by mixing the aqueous medium with the first dry powdery aluminum hydroxide. As a method for mixing the aqueous medium and the first dry powdery aluminum hydroxide, a method comprising continuously mixing the aqueous medium and the first dry powdery aluminum hydroxide without applying a substantial pressure to the dry powdery aluminum hydroxide is preferable. As such a method, it is preferred to employ a method comprising continuously spraying the first dry powdery aluminum hydroxide and concurrently spraying the aqueous medium on the hydroxide dry powder. In a mixing method using a V-type mixer, a tumbling granulator, etc., the dry powdery aluminum hydroxide and the aqueous medium are mixed so that the bulk density of the aluminum hydroxide after drying increases. However, as a result of the excessive compaction of the aluminum hydroxide during mixing, the granulated aluminum hydroxide is obtained and thus the alumina powder prepared by calcination maintains the granulated shape of the particles to form rigid agglomerated particles, so that the alumina powder may be hardly milled. Thus, such a method using a twin-cylinder mixer, a tumbling granulator, etc. is not preferable.

The amount of the aqueous medium in the mixture is 20 parts by weight or more and 300 parts by weight or less, preferably 50 parts by weight or more and 180 parts by weight or less, per 100 parts by weight of the first dry powdery aluminum hydroxide. When the amount of the aqueous medium is less than 20 parts by weight, it is difficult to uniformly mix the aqueous medium with the first dry powdery aluminum hydroxide, and in some cases, the second dry powdery aluminum hydroxide with a high bulk density may not be obtained. When the amount of the aqueous medium exceeds 300 parts by weight, the amount of energy required for drying the wet powdery aluminum hydroxide increases and a longer drying time is necessary, which is not preferable from the view point of production costs.

The second dry powdery aluminum hydroxide is obtained by drying the wet powdery aluminum hydroxide obtained in the previous step. The drying method is preferably a method comprising evaporating the aqueous medium by heating. Such a method can shorten the drying time and enhance work efficiency. The heating temperature is not particularly limited, but it is preferably not lower than the boiling point of the aqueous medium used.

As a drying system, an agitation drying system which applies an external force to the wet powdery aluminum hydroxide such as a rotary drier, a fluidized-bed drier, a vibration conveying drier, etc. is used. The use of such a drying system can form the dry powdery aluminum hydroxide having a higher bulk density. If a static dryer which does not apply any external force to the wet powdery aluminum hydroxide is used, the dry powdery aluminum hydroxide having a high bulk density may not be obtained when the amount of the aqueous medium is small.

The bulk density of the second dry powdery aluminum hydroxide thus obtained is usually from 0.3 to 0.8 g/cm³, preferably from 0.4 to 0.8 g/cm³, and it is higher than that of the first dry powdery aluminum hydroxide. Therefore, the aluminum hydroxide can be calcined with being filled in a calcination vessel at a higher filling rate as described later. Accordingly, alumina can be produced at a high volume efficiency. The second dry powdery aluminum hydroxide usually has a BET specific surface area of about 100 to 200 m²/g and an average secondary particle diameter of about 5 to 100 μm.

The desired alumina can be obtained by calcining the second dry powdery aluminum hydroxide. Usually, alumina hydroxide is calcined with being filled in a calcination vessel. An example of the calcination vessel is a sheath. The calcination vessel is preferably made of alumina from the viewpoint of preventing contamination.

Examples of a calcination furnace include static calcination furnaces such as a tunnel kiln, a batchwise ventilation-type box calcination furnace and a batchwise parallel-current type box calcination furnace. Also, a rotary kiln can be used.

Examples of alumina obtained by calcination include α-alumina having the α-form crystal structure, γ-alumina having the γ-form crystal structure, δ-alumina having the δ-form crystal structure, η-alumina having the η-form crystal structure, θ-alumina having the θ-form crystal structure, κ-alumina having the κ-form crystal structure, ρ-alumina having the ρ-form crystal structure, and χ-alumina having the χ-form crystal structure.

A calcining temperature, a heating rate up to the calcining temperature and a calcining time are appropriately selected depending on the crystal structure of desired alumina. When the desired alumina is α-alumina, the calcining temperature is from 1100 to 1450° C., preferably from 1200 to 1350° C., the heating rate up to the calcining temperature is usually from 30 to 500° C/hr., and the calcining time is usually from 0.5 to 24 hours and preferably from 1 to 10 hours.

The calcination may be performed in atmospheric air or an atmosphere of an inert gas such as a nitrogen gas or an argon gas. Also, the calcination may be performed in an atmosphere in which a partial pressure of water vapor is high, as in the case of a gas furnace which performs calcination by the combustion of a propane gas or the like.

With regard to the physical properties of alumina obtained by the above-described calcination, in the case of α-alumina, a BET specific surface area is usually from 2 to 20 m²/g and an average secondary particle diameter is usually from about 10 to 200 μm.

Since the particles of obtained alumina are agglomerated in some cases, the agglomerated particles may be pulverized depending on the intended use. The pulverization method is not particularly limited, and a conventional apparatus such as a vibration mill, a ball mill or a jet mill may be used. Either a dry system or a wet system may be used. A pulverizing method using a jet mill is preferable as a method for pulverizing the agglomerates to provide alumina containing no coarse agglomerates with maintaining the purity of alumina.

The pulverization is performed until the average secondary particle diameter of α-alumina reaches, for example, 1 μm or less. The BET specific surface area of powdery α-alumina obtained by the pulverization is usually from 2 to 20 m²/g.

The powdery α-alumina is used as, for example, a raw material for making a porous film having heat-resistance and electrical insulation properties, which is coated on the surface of an electrode of a secondary lithium ion battery to improve the safety of the battery in the case of internal short-circuiting. Furthermore, the powdery α-alumina may be used as a raw material for preparing a phosphor.

The powdery α-alumina is also useful as a raw material for producing an α-alumina sintered body. The α-alumina sintered body is suitable for applications which require high strength, such as a cutting tool, bioceramics, etc. Examples of other applications of the α-alumina sintered body include components of apparatuses for producing semiconductors such as a wafer handler; heat-conductive fillers; translucent tubes of a sodium lamp, a metal halide lamp, etc.; and ceramic filters used for removal of solid substances contained in gases such as exhaust gas, etc., for filtration of aluminum molten metal, and for filtration of food and beverages such as beer, etc. An example of the ceramic filter is a permselective filter for selectively permeating hydrogen in a fuel cell or selectively permeating gas components (e.g., carbon monoxide, carbon dioxide, nitrogen, oxygen, etc.) generated during petroleum refining. In addition, the α-alumina sintered body can be used as a catalyst carrier for carrying a catalyst component on the surface of the permselective filter.

### Examples

Hereinafter, the present invention will be illustrated by making reference to the Examples, which do not limit the scope of the present invention in any way. The methods for evaluating physical properties were as follows.

Bulk Density:

A bulk density was measured in accordance with JIS Z8901.

BET Specific Surface Area:

A BET specific surface area was measured by a nitrogen adsorption method according to the method described in JIS Z8830. As an apparatus for measuring a BET specific surface area, “FlowSorb II 2300” manufactured by Shimadzu Corporation was used.

Average Secondary Particle Diameter:

A particle diameter distribution curve was obtained using an apparatus for measuring particle diameter distribution (“Microtrack HRA X-100” manufactured by Honeywell) based on the laser scattering method, and the average secondary particle diameter was determined as a particle diameter corresponding to the diameter of particles at a cumulative percentage of 50% by weight. Before the measurement, the particles were ultrasonically dispersed using a 0.2% by weight solution of sodium hexamethaphosphate in water.

Content of Coarse Agglomerated Particles Having a Particle Diameter of 10 μm or more:

An α-alumina slurry was prepared by adding 30 g of α-alumina powder after pulverization to 4000 g of deionized water containing 0.2% of sodium hexametaphosphate as a dispersant and dispersing the α-alumina powder in water while applying ultrasonic wave. The slurry was passed through a sieve having an opening of 10 μm, and the α-alumina remaining on the sieve was collected and weighed. Then, the content of the coarse agglomerated particles having a particle diameter of 10 μm or more was calculated.

### Example 1

Firstly, aluminum isopropoxide as an aluminum alkoxide was hydrolyzed with water to form a slurry of aluminum hydroxide, and the slurry was dried to obtain a first dry powdery aluminum hydroxide. The first dry powdery aluminum hydroxide had a bulk density of 0.12 g/cm³, a BET specific surface area of 294 m²/g and an average secondary particle diameter of 11.0 μm.

Then, 100 parts by weight of the first dry powdery aluminum hydroxide was mixed with 58 parts by weight of water as an aqueous medium using a continuous jet mixer (“Mw-F300S” manufactured by Funken Powtechs Inc.) to obtain a wet powdery aluminum hydroxide.

The wet powdery aluminum hydroxide was charged in a SUS-made 13 Liter vessel equipped with agitating blades and dried while agitating the powder to evaporate water. Thereby, a second dry powdery aluminum hydroxide was obtained. The second dry powdery aluminum hydroxide had a bulk density of 0.45 g/cm³, a BET specific surface area of 183 m²/g, and an average secondary particle diameter of 18.3 μm.

Further, the second dry powdery aluminum hydroxide was maintained and calcined in a furnace, which clcines a material by burning propane gas, etc., at a temperature of 1280° C. for 7 hours to obtain α-alumina. An aluminous sheath was used for calcination.

The obtained α-alumina was agglomerated so that it had a BET specific surface area of 3.5 m²/g and an average secondary particle diameter of 34 μm. Therefore, the α-alumina agglomerates were pulverized with a jet mill (“PJM-280” manufactured by Nippon Pneumatic Mfg. Co., Ltd.). The jet milling conditions included an α-alumina supplying rate of 8 kg/hr. and a milling pressure of 0.49 MPa. As a result, the α-alumina powder having a BET specific surface area of 4.1 m²/g and an average secondary particle diameter of 0.63 μm and containing 3 ppm or less of coarse agglomerates having a particle diameter of 10 μm or more was obtained.

### Example 2

Firstly, the same aluminum alkoxide as one used in Example 1 was hydrolyzed to obtain a first dry powdery aluminum hydroxide having the same physical properties as one obtained in Example 1. Then, a second dry powdery aluminum hydroxide was prepared in the same manner as in. Example 1 except that 100 parts by weight of the first dry powdery aluminum hydroxide and 82 parts by weight of water as an aqueous medium were mixed with a continuous jet mixer. The obtained second dry powdery aluminum hydroxide had a bulk density of 0.74 g/cm³, a BET specific surface area of 145 m²/g and an average secondary particle diameter of 80.9 μm.

Thereafter, the second dry powdery aluminum hydroxide was calcined in the same manner as in Example 1 to obtain α-alumina. The obtained α-alumina was agglomerated so that it had a BET specific surface area of 3.2 m²/g and an average secondary particle diameter of 132 μm. Therefore, the α-alumina agglomerates were pulverized in the same manner as in Example 1. As a result, the α-alumina powder having a BET specific surface area of 4.4 m²/g and an average secondary particle diameter of 0.62 μm and containing 3 ppm or less of coarse agglomerates having a particle diameter of 10 μm or more was obtained.

### Comparative Example 1

Firstly, a wet powdery aluminum hydroxide was prepared in the same manner as in Example 1.

Then, the wet powdery aluminum hydroxide was spread over a stainless steel tray and dried by a static drying system in atmospheric air by placing the tray in a constant-temperature dryer kept at 200° C. to evaporate the aqueous medium, whereby a second aluminum oxide dry powder was obtained. The resulting second dry powdery aluminum hydroxide had a bulk density of 0.33 g/cm³, a BET specific surface area of 176 m²/g and an average secondary particle diameter of 12.3 μm.

Since the amount of water added to the first aluminum oxide dry powder was small and the static drying system was used, the increase degree of a bulk density of the second aluminum oxide dry powder was small.

### Comparative Example 2

Firstly, the same aluminum hydroxide as one used in Example 1 was hydroxide hydrolyzed in the same manner as in Example 1 to obtain the first dry powdery aluminum hydroxide having the same physical properties as one obtained in Example 1. Then, 100 parts of this first dry powdery aluminum hydroxide and 50 parts by weight of water as an aqueous medium were mixed using a dish-type granulator while sparging water over the powder, and the mixture was dried by a static drying system to obtain aluminum hydroxide granules having a particle diameter of about 2 mm. The second dry powdery aluminum hydroxide had a bulk density of 0.44 g/cm³.

The second dry powdery aluminum hydroxide was calcined in the same manner as in Example 1. The resulting α-alumina had a particle diameter of 1.8 mm and a BET specific surface area of 2.8 m²/g, which were the same as those of the granules, and the α-alumina formed rigid agglomerates, which could not be pulverized.

What is claimed is:

1. A method for producing alumina comprising the steps of:
mixing an aqueous medium in an amount of 20 parts by weight or more and 300 parts by weight or less with 100 parts by weight of a first dry powdery aluminum hydroxide prepared by an aluminum alkoxide method to give a wet powdery aluminum hydroxide;
drying the wet powdery aluminum hydroxide by an agitation drying system to give a second dry powdery aluminum hydroxide; and
calcining the second dry powdery aluminum hydroxide to give alumina.

2. The method according to claim 1, wherein said aqueous medium is water.

3. The method according to claim 1, wherein the amount of the aqueous medium is 50 parts by weight or more and 180 parts by weight or less per 100 parts by weight of the first dry powdery aluminum hydroxide.

4. The method according to claim 1, wherein the calcination is performed in atmospheric air.
